(19) United States
(12) Patent Application Publication
(10) Pub. No.: US 2013/0066979 A1
(43) Pub. Date: Mar. 14, 2013

(54) DISTRIBUTING EVENTS TO LARGE NUMBERS OF DEVICES

(71) Applicant: Clemens Friedrich Vasters, Kirkland, WA (US)

(72) Inventor: Clemens Friedrich Vasters, Kirkland, WA (US)

(73) Assignee: Microsoft Corporation, Redmond, WA (US)

(21) Appl. No.: 13/278,401

(22) Filed: Oct. 21, 2011

Related U.S. Application Data
(60) Provisional application No. 61/533,657, filed on Sep. 12, 2011.
(60) Provisional application No. 61/533,669, filed on Sep. 12, 2011.

(51) Int. Cl. G06F 15/16

(52) U.S. Cl. 709/206

(57) ABSTRACT

Distributing events to a large number of event consumers in a fashion that may minimize message copying and message latency. A method includes determining that an event should be sent to a set of specific consumers. The method further includes copying the event and providing individual copies to a plurality of distribution partitions. The method further includes, at each of the distribution partitions packaging a copy of the event with a plurality of routing slips to create a plurality of delivery bundles. The routing slips describing a plurality of individual consumers intended to receive the event. The method further includes using the delivery bundles, distributing the events to individual consumers as specified in the routing slips.

### CROSS-REFERENCE TO RELATED APPLICATIONS

This application claims the benefit of U.S. Provisional application 61/533,657 filed Sep. 12, 2011, titled “SCALE-OUT SYSTEM TO DISTRIBUTE EVENTS TO A LARGE NUMBER OF DEVICES IN A TIMELY FASHION” and U.S. Provisional application 61/533,669 filed Sep. 12, 2011, titled “SYSTEM TO DISTRIBUTE MOBILE PUSH NOTIFICATIONS SOURCED FROM A VARIETY OF EVENT SOURCES TARGETS WITH CUSTOMIZED MAPPING OF EVENT DATA TO NOTIFICATIONS” which are incorporated herein by reference in their entirety.

### BACKGROUND

### Background and Relevant Art

Computers and computing systems have affected nearly every aspect of modern living. Computers are generally involved in work, recreation, healthcare, transportation, entertainment, household management, etc.

Further, computing system functionality can be enhanced by a computing systems ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing system.

Many computers are intended to be used by direct user interaction with the computer. As such, computers have input hardware and software user interfaces to facilitate user interaction. For example, a modern general purpose computer may include a keyboard, mouse, touchpad, camera, etc for allowing a user to input data into the computer. In addition, various software user interfaces may be available.

Examples of software user interfaces include graphical user interfaces, text command line based user interface, function key or hot key user interfaces, and the like.

Assume a developer who builds a mobile app on iOS, Android, Windows Phone, Windows, etc. that focuses on delivering general-interest news, information and facts on world events or for sports fans of soccer, football, hockey, or baseball leagues or teams to keep them up-to-date. For any of these applications (and a broad variety of other apps) notifications that pop alerts or toasts as the fan's favorite team scores or a certain kind of news events breaks in the world are a great differentiator. That differentiator commonly implements building and running server infrastructure to push those events into vendor-supplied notification channels which is beyond the skill set of many mobile application (“app”) developers focusing on optimized user experiences. And if their app is very successful, simple server-based solutions will soon hit scalability ceilings as distributing events to tens or even hundreds of thousands of devices in a timely fashion is very challenging.

Timeliness may be an important value proposition for many of these kinds of applications. For example, sports fans do not have a lot of patience when it comes to being up-to-date. Similarly, individuals and institutions who are watching aspects of their financial portfolio hitting thresholds, people who are participating in a large auction, or players whose virtual agricultural empire on Facebook is about to be hit by a passing hurricane often do not have a lot of patience when it comes to being up to date.

Apple's Push Notification Services for iOS, Google's C2DM service for Android, and Microsoft's MPNS service for Windows Phone, and most other mobile platforms provide some form of an optimized shared connection into the device providing maximum energy (and thus battery) efficiency and allow applications to leverage this shared channel via the respective platform's push notifications API. However, as discussed above, it may be difficult and/or require large amounts of computing resources to distribute large numbers of notifications based on a single event using these platforms.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment herein is directed to a method that may be practiced in a computing environment. The method includes acts for distributing events to a large number of event consumers in a fashion that may minimize message copying and message latency. The method includes determining that an event should be sent to a set of specific consumers. The method further includes copying the event and providing individual copies to a plurality of distribution partitions. The method further includes, at each of the distribution partitions packaging a copy of the event with a plurality of routing slips to create a plurality of delivery bundles. The routing slips describing a plurality of individual consumers intended to receive the event. The method further includes using the delivery bundles, distributing the events to individual consumers as specified in the routing slips.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example of an event data distribution system;

FIG. 2 illustrates an event data acquisition and distribution system; and

FIG. 3 illustrates a method of distributing events.

### DETAILED DESCRIPTION

Some embodiments described herein leverage push notification mechanisms and provide a notification management and distribution layer on top that allows mobile and desktop developers to leverage these push notification channels at scale and with very timely distribution characteristics.

Some embodiments may include a method to perform broadcast of notifications through a cascading and partitioned distribution and delivery system that minimizes the number of messages copies and can scale to a very large number of delivery targets while also minimizing the average flow time of a notification from ingress to egress for each individual target.

Some embodiments may include a method to collect and flow delivery statistics into a data warehouse solution for purposes of systems monitoring as well as client and 3rd party billing.

Some embodiments may include a method to temporarily or permanently blacklist targets due to temporary or permanent delivery error conditions.

As a foundation, one embodiment system is using a publish/subscribe infrastructure as provided by Windows Azure Service Bus available from Microsoft Corporation of Redmond Wash., but which also exists in similar form in various other messaging systems. The infrastructure provides two capabilities that facilitate the described implementation of the presented method: Topics and Queues.

A Queue is a storage structure for messages that allows messages to be added (enqueued) in sequential order and to be removed (dequeued) in the same order as they have been added. Messages can be added and removed by any number of concurrent clients, allowing for leveling of load on the enqueue side and balancing of processing load across receivers on the dequeue side. The queue also allows entities to obtain a lock on a message as it is dequeued, allowing the consuming client explicit control over when the message is actually deleted from the queue or whether it may be restored into the queue in case the processing of the retrieved message fails.

A Topic is a storage structure that has all the characteristics of a Queue, but allows for multiple, concurrently existing ‘subscriptions’ which each allow an isolated, filtered view over the sequence of enqueued messages. Each subscription on a Topic yields a copy of each enqueued message provided that the subscription's associated filter condition(s) positively match the message. As a result, a message enqueued into a Topic with 10 subscriptions where each subscription has a simple ‘passthrough’ condition matching all messages, will yield a total of 10 messages, one for each subscription. A subscription can, like a Queue, have multiple concurrent consumers providing balancing of processing load across receivers.

Another foundational concept is that of ‘event’, which is, in terms of the underlying publish/subscribe infrastructure just a message. In the context of one embodiment, the event is subject to a set of simple constraints governing the use of the message body and message properties. The message body of an event generally flows as an opaque data block and any event data considered by one embodiment generally flows in message properties, which is a set of key/value pairs that is part of the message representing the event.

Embodiments may be configured to distribute a copy of information from a given input event to each of a large number of ‘targets 102’ that are associated with a certain scope and do so in minimal time for each target 102. A target 102 may include an address of a device or application that is coupled to the identifier of an adapter to some 3rd party notification system or to some network accessible external infrastructure and auxiliary data to access that notification system or infrastructure.

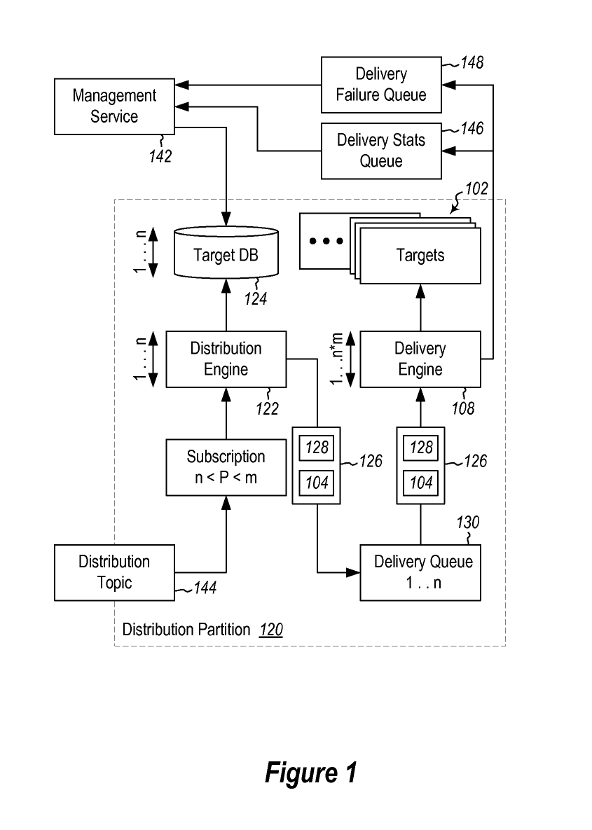

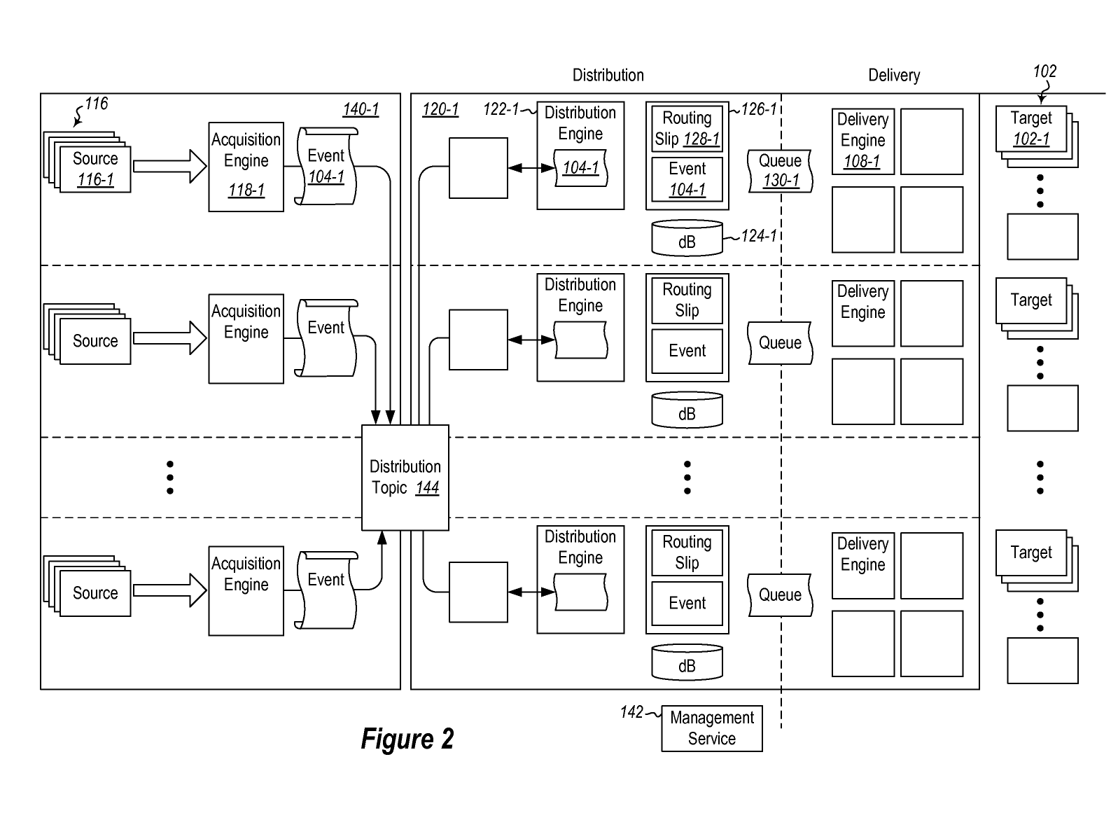

Some embodiments may include an architecture that is split up into three distinct processing roles, which are described in the following in detail and can be understood by reference to FIG. 1. As noted in FIG. 1 by the ‘1’, the ellipses, and ‘n’, each of the processing roles can have one or more instances of the processing role. Note that the use of ‘n’ in each case should be considered distinct from each other case as applied to the processing roles, meaning that each of the processing roles do not need to have the same number of instances. The ‘distribution engine’ 112 role accepts events and bundles them with routing slips (see e.g. routing slip 128-1 in FIG. 2) containing groups of targets 102. The ‘delivery engine’ 108 accepts these bundles and processes the routing slips for delivery to the network locations represented by the targets 102. The ‘management role’ illustrated by the management service 142 provides an external API to manage targets 102 and is also responsible for accepting statistics and error data from the delivery engine 108 and for processing/storing that data.

The data flow is anchored on a ‘distribution topic 144’ into which events are submitted for distribution. Submitted events are labeled, using a message property, with the scope they are associated with—which may be one of the aforementioned constraints that distinguish events and raw messages.

The distribution topic 144, in the illustrated example, has one passthrough (unfiltered) subscription per ‘distribution partition 120’. A ‘distribution partition’ is an isolated set of resources that is responsible for distributing and delivering notifications to a subset of the targets 102 for a given scope. A copy of each event sent into the distribution topic is available to all concurrently configured distribution partitions at effectively the same time through their associated subscriptions, enabling parallelization of the distribution work.

Parallelization through partitioning helps to achieve timely distribution. To understand this, consider a scope with 10 million targets 102. If the targets' data was held in an unpartitioned store, the system would have to traverse a single, large database result set in sequence or, if the results sets were acquired using partitioning queries on the same store, the throughput for acquiring the target data would at least be throttled by the throughput ceiling of the given store's fronting network gateway infrastructure, as a result, the delivery latency of the delivery of notifications to targets 102 whose description records occur very late in the given result sets will likely be dissatisfactory.

If, instead, the 10 million targets 102 are distributed across 1,000 stores that each hold 10,000 target records and those stores are paired with dedicated compute infrastructure (distribution engine 122′ and ‘delivery engine 108’ described herein) performing the queries and processing the results in form of partitions as described here, the acquisition of the target descriptions can be parallelized across a broad set of compute and network resources, significantly reducing the time difference for distribution of all events measured from the first to the last event distributed.

The actual number of distribution partitions is not technically limited. It can range from a single partition to any number of partitions greater than one.

In the illustrated example, once the ‘distribution engine 122’ for a distribution partition 120 acquires an event 104, it first computes the size of the event data and then computes the size of the routing slip 128, which may be calculated based on delta between the event size and the lesser of the allowable maximum message size of the underlying messaging system and an absolute size ceiling. Events are limited in size in such a way that there is some minimum headroom for ‘routing slip’ data.

The routing slip 128 is a list that contains target 102 descriptions. Routing slips are created by the distribution engine 122 by performing a lookup query matching the event's scope against the targets 102 held in the partition's store 124, returning all targets 102 matching the event's scope and a set of further conditions narrowing the selection based on filtering conditions on the event data. Embodiments may include amongst those filter conditions a time window condition that will limit the result to those targets 102 that are considered valid at the current instant, meaning that the current UTC time is within a start/end validity time window contained in the target description record. This facility is used for blacklisting, which is described later in this document. As the lookup result is traversed, the engine creates a copy of the event 104, fills the routing slip 128 up to the maximum size with target descriptions retrieved from the store 124, and then enqueues the resulting bundle of event and routing slip into the partition's ‘delivery queue 130’.

The routing slip technique ensures that the event flow velocity of events from the distribution engine 122 to the delivery engine(s) 108 is higher than the actual message flow rate on the underlying infrastructure, meaning that, for example, if 30 target descriptions can be packed into a routing slip 128 alongside the event data, the flow velocity of event/target pairs is 30 times higher than if the event/target pairs were immediately grouped into messages.

The delivery engine 108 is the consumer of the event/routing-slip bundles 126 from the delivery queue 130. The role of the delivery engine 108 is to dequeue these bundles, and deliver the event 104 to all destinations listed in the routing slip 128. The delivery commonly happens through an adapter that formats the event message into a notification message understood by the respective target infrastructure. For example, the notification message may be delivered in a MPNS format for Windows® 7 phone, APN (Apple Push Notification) formats for iOS devices, C2DM (Cloud To Device Messaging) formats for Android devices, JSON (Java Script Object Notation) formats for browsers on devices, HTTP (Hyper Text Tranfer Protocol), etc

The delivery engine 108 will commonly parallelize the delivery across independent targets 102 and serialize delivery to targets 102 that share a scope enforced by the target infrastructure. An example for the latter is that a particular adapter in the delivery engine may choose to send all events targeted at a particular target application on a particular notification platform through a single network connection.

The distribution and delivery engines 122 and 108 are decoupled using the delivery queue 130 to allow for independent scaling of the delivery engines 108 and to avoid having delivery slowdowns back up into and block the distribution query/packing stage.

Each distribution partition 120 may have any number of delivery engine instances that concurrently observe the delivery queue 130. The length of the delivery queue 130 can be used to determine how many delivery engines are concurrently active. If the queue length crosses a certain threshold, new delivery engine instances can be added to the partition 120 to increase the send throughput.

Distribution partitions 120 and the associated distribution and delivery engine instances can be scaled up in a virtually unlimited fashion in order to achieve optimal parallelization at high scale. If the target infrastructure is capable of receiving and forwarding one million event requests to devices in an in-parallel fashion, the described system is capable of distributing events across its delivery infrastructure—potentially leveraging network infrastructure and bandwidth across datacenters—in a way that it can saturate the target infrastructure with event submissions for a delivery to all desired targets 102 that is as timely as the target infrastructure will allow under load and given any granted delivery quotas.

As messages are delivered to the targets 102 via their respective infrastructure adapters, in some embodiments, the system takes note of a range of statistical information items. Amongst those are measured time periods for the duration between receiving the delivery bundle and delivery of any individual message and the duration of the actual send operation. Also part of the statistics information is an indicator on whether a delivery succeeded or failed. This information is collected inside the delivery engine 108 and rolled up into averages on a per-scope and on a per-target-application basis. The ‘target application’ is a grouping identifier introduced for the specific purpose of statistics rollup. The computed averages are sent into the delivery stats queue 146 in defined intervals. This queue is drained by a (set of) worker(s) in the management service 142, which submits the event data into a data warehouse for a range of purposes. These purposes may include, in addition to operational monitoring, billing of the tenant for which the events have been delivered and/or disclosure of the statistics to the tenant for their own billing of 3rd parties.

As delivery errors are detected, these errors are classified into temporary and permanent error conditions. Temporary error conditions may include, for example, network failures that do not permit the system to reach the target infrastructure's delivery point or the target infrastructure reporting that a delivery quota has been temporarily reached. Permanent error conditions may include, for example, authentication/authorization errors on the target infrastructure or other errors that cannot be healed without manual intervention and error conditions where the target infrastructure reports that the target is no longer available or willing to accept messages on a permanent basis. Once classified, the error report is submitted into the delivery failure queue 148. For temporary error conditions, the error may also include the absolute UTC timestamp until when the error condition is expected to be resolved. At the same time, the target is locally blacklisted by the target adapter for any further local deliveries by this delivery engine instance. The blacklist may also include the timestamp.

The delivery failure queue 148 is drained by a (set of) worker(s) in the management role. Permanent errors may cause the respective target to be immediately deleted from its respective distribution partition store 124 to which the management role has access. ‘Deleting’ may mean that the record is indeed removed or alternatively that the record is merely moved out of sight of the lookup queries by setting the ‘end’ timestamp of its validity period to the timestamp of the error. Temporary error conditions may cause the target to be deactivated for the period indicated by the error. Deactivation may be done by moving the start of the target's validity period up to the timestamp indicated in the error at which the error condition is expected to be healed.

Referring now to FIG. 2, an alternate illustration is shown. As intimated previously, embodiments may be particularly useful in a message fan-out system where a single event is fanned out to a plurality (and potentially large number) of end users. Such an example is illustrated in FIG. 2. FIG. 2 illustrates an example where information from a large number of different sources is delivered to a large number of different targets. In some examples, information from a single source, or information aggregated from multiple sources, may be used to create a single event that is delivered to a large number of the targets. This may be accomplished, in some embodiments, using a fan-out topology as illustrated in FIG. 2.

FIG. 2 illustrates the sources 116. As will be discussed later herein, embodiments may utilize acquisition partitions 140. Each of the acquisition partitions 140 may include a number of sources 116. There may be potentially a large number and a diversity of sources 116. The sources 116 provide information. Such information may include, for example but not limited to, email, text messages, real-time stock quotes, real-time sports scores, news updates, etc.

FIG. 2 illustrates that each partition includes an acquisition engine, such as the illustrative acquisition engine 118. The acquisition engine 118 collects information from the sources 116, and based on the information, generates events. In the example illustrated in FIG. 2, a number of events are illustrated as being generated by acquisition engines using various sources. An event 104-1 is used for illustration. In some embodiments, the event 104-1 may be normalized as explained further herein. The acquisition engine 118 may be a service on a network, such as the Internet, that collects information from sources 116 on the network.

FIG. 2 illustrates that the event 104-1 is sent to a distribution topic 144. The distribution topic 144 fans out the events to a number of distribution partitions. Distribution partition 120-1 is used as an analog for all of the distribution partitions. The distribution partitions each service a number of end users or devices represented by subscriptions. The number of subscriptions serviced by a distribution partition may vary from that of other distribution partitions. In some embodiments, the number of subscriptions serviced by a partition may be dependent on the capacity of the distribution partition. Alternatively or additionally, a distribution partition may be selected to service users based on logical or geographical proximity to end users. This may allow alerts to be delivered to end users in a more timely fashion.

In the illustrated example, distribution partition 120-1 includes a distribution engine 122-1. The distribution engine 122-1 consults a database 124-1. The database 124-1 includes information about subscriptions with details about the associated delivery targets 102. In particular, the database may include information such as information describing platforms for the targets 102, applications used by the targets 102, network addresses for the targets 102, user preferences of end users using the targets 102, etc. Using the information in the database 124-1, the distribution engine 122-1 constructs a bundle 126-1, where the bundle 126-1 includes the event 104 (or at least information from the event 104) and a routing slip 128-1 identifying a plurality of targets 102 from among the targets 102 to which information from the event 104-1 will be sent as a notification. The bundle 126-1 is then placed in a queue 130-1.

The distribution partition 120-1 may include a number of delivery engines. The delivery engines dequeue bundles from the queue 103-1 and deliver notifications to targets 102. For example, a delivery engine 108-1 can take the bundle 126-1 from the queue 13-1 and send the event 104 information to the targets 102 identified in the routing slip 128-1. Thus, notifications 134 including event 104-1 information can be sent from the various distribution partitions to targets 102 in a number of different formats appropriate for the different targets 102 and specific to individual targets 102. This allows individualized notifications 134, individualized for individual targets 102, to be created from a common event 104-1 at the edge of a delivery system rather than carrying large numbers of individualized notifications through the delivery system.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

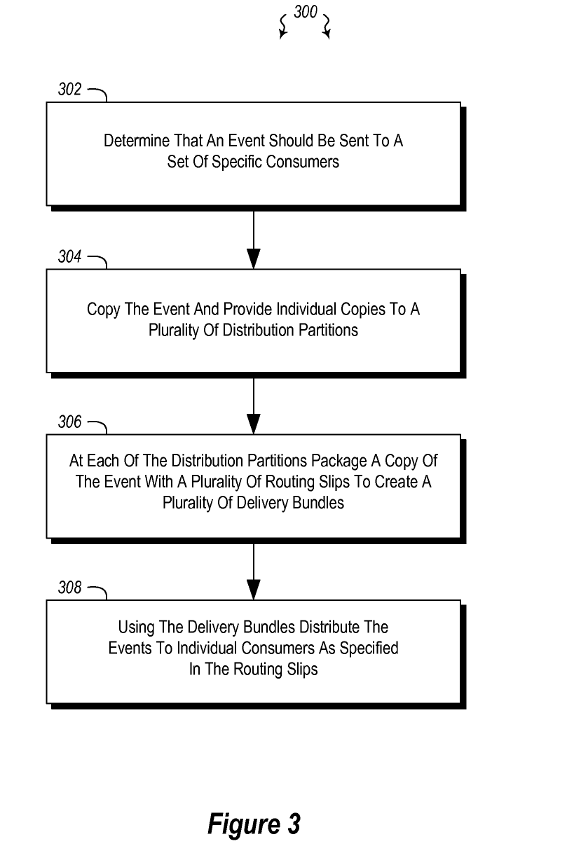

Referring now to FIG. 3, a method 300 is illustrated. The method may be practiced in a computing environment. The method includes acts for distributing events to a large number of event consumers in a fashion that may minimize message copying and message latency. The method includes determining that an event should be sent to a set of specific consumers (act 302). For example, as illustrated in FIG. 2, an event 104 may need to be sent to one or more of targets 102.

The method further includes copying the event and providing individual copies to a plurality of distribution partitions (act 304). For example, as illustrated in FIG. 2, the event is copied at the distribution topic to a number of distribution partitions such as distribution partition 120-1 and the other distribution partitions shown.

The method further includes at each of the distribution partitions packaging a copy of the event with a plurality of routing slips to create a plurality of delivery bundles (act 306). The routing slips may describe a plurality of individual consumers intended to receive the event. Examples of such a delivery bundle is illustrated at 126-1 in FIG. 2.

The method further includes using the delivery bundles distributing the events to individual consumers as specified in the routing slips (act 308). For example, as illustrated in FIG. 2, a delivery engine 108-1 may be able to, using the routing slip 128-1, deliver the event 104 to various targets 102.

Some embodiments of the method 300 may be practiced where the partitions are determined based on partition capacity. For example, the number of targets an event will be distributed to by a delivery partition may be determined by the capacity, as determined by factors such as system hardware, network connection, current load, etc.

Some embodiments of the method 300 may be practiced where the partitions are determined by locale. For example, a partition, such as partition 120-1, may be assigned targets that are in close geographical or logical proximity to the partition.

Some embodiments of the method 300 may be practiced where the routing slips define rules and constraints for how to deliver the event to individual consumers. For example, the routing slips may include consumer specific filter. In one example, a consumer (i.e. a target user) may define preferences about what types of events to receive or not receive. This information can be included in the routing slip such that decisions about whether or not to deliver an event can be made at the edge of the delivery system by a delivery engine.

In an alternative or additional embodiment, the routing slips may define a network location rule. For example, the routing slips may include a network path to reach a particular target.

In an alternative or additional embodiment, the routing slips may include security credential information. For example, security credentials may be needed for an event to be delivered. In particular, an application on a device may expect some security protocol information when communicating with a server providing event data. This security protocol information can be included by the delivery engine 108-1 to ensure that events are delivered properly.

In an alternative or additional embodiment, the routing slips may include rules to map raw event data to format expected by consumer. For example, the event may be in a generic form, but the routing slip may define a platform for a target. This allows the delivery engine 108-1 to format in event 104 in a particular format suitable for the defined platform before delivering the event to the target.

Methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of distributing events to a large number of event consumers in a fashion that may minimize message copying and message latency, the method comprising:
determining that an event should be sent to a set of specific consumers;
copying the event and providing individual copies to a plurality of distribution partitions;
at each of the distribution partitions packaging a copy of the event with a plurality of routing slips to create a plurality of delivery bundles, the routing slips describing a plurality of individual consumers intended to receive the event; and
using the delivery bundles distributing the event to individual consumers as specified in the routing slips.

2. The method of claim 1, wherein the distribution partitions are determined based on distribution partition capacity.

3. The method of claim 1, wherein the partitions are determined by locale.

4. The method of claim 1, wherein the routing slips define rules and constraints for how to deliver the event to individual consumers.

5. The method of claim 4, wherein the constraints define user preferences, and wherein using the delivery bundles distributing the event to individual consumers as specified in the routing slips comprises determining whether or not to deliver an event based on the user preferences in the routing slip.

6. The method of claim 4, wherein the constraints define rules to map raw event data to platform specific formats for individual consumer devices.

7. The method of claim 1, wherein the routing slips comprise security credential information.

8. A computer readable medium comprising computer executable instructions that when executed by one or more processors cause one or more processors to perform the following:
determining that an event should be sent to a set of specific consumers;
copying the event and providing individual copies to a plurality of distribution partitions;
at each of the distribution partitions packaging a copy of the event with a plurality of routing slips to create a plurality of delivery bundles, the routing slips describing a plurality of individual consumers intended to receive the event; and
using the delivery bundles distributing the event to individual consumers as specified in the routing slips.

9. The computer readable medium of claim 9, wherein the distribution partitions are determined based on distribution partition capacity.

10. The computer readable medium of claim 9, wherein the partitions are determined by locale.

11. The computer readable medium of claim 9, wherein the routing slips define rules and constraints for how to deliver the event to individual consumers.

12. The computer readable medium of claim 11, wherein the constraints define user preferences, and wherein using the delivery bundles distributing the event to individual consumers as specified in the routing slips comprises determining whether or not to deliver an event based on the user preferences in the routing slip.

13. The computer readable medium of claim 11, wherein the constraints define rules to map raw event data to platform specific formats for individual consumer devices.

14. The computer readable medium of claim 9, wherein the routing slips comprise security credential information.

15. A computing system configured to distribute events to a large number of event consumers, the computing system comprising:
a distribution partition, wherein the distribution partition is a distribution partition among a plurality of distribution partitions, wherein the distribution partition, is configured to receive an event for distribution to end consumer devices where the same event can be provided to each of the distribution partitions in the plurality of distribution partitions, and wherein the distribution partition comprises:
a distribution engine, the distribution engine being configured to bundle the event with a routing slip into a bundle, the routing slip containing groups of target end consumer devices for the event;
a target database coupled to the distribution engine, the target database comprising information about subscriptions for events for end user consumer devices, wherein the subscriptions can be used by the distribution engine to bundle the event with a routing slip;
a delivery queue coupled to the distribution engine, wherein the deliver queue is configured to receive bundles from the distribution engine; and
one or more delivery engines, wherein the one or more delivery engines are configured to distribute the event to individual consumers as specified in the routing slip

16. The computing system of claim 15, wherein the distribution partition is determined based on distribution partition capacity.

17. The computing system of claim 15, wherein the distribution partition is determined by locale.

18. The computing system of claim 15, wherein the routing slip defines rules and constraints for how to deliver the event to individual consumers.

19. The computing system of claim 18, wherein the constraints define user preferences, and wherein using the delivery bundles distributing the event to individual consumers as specified in the routing slips comprises determining whether or not to deliver an event based on the user preferences in the routing slip.

20. The computing system of claim 18, wherein the constraints define rules to map raw event data to platform specific formats for individual consumer devices.
